(19) United States
(12) Patent Application Publication
(10) Pub. No.: US 2011/0236690 A1
(43) Pub. Date: Sep. 29, 2011

(54) Polymer laminar composite having improved layer adhesion

(75) Inventors: Ayse Cochet, Koln (DE); Joachim Wagner, Koln (DE); Werner Jenninger, Koln (DE); Stefan Spange, Orlamunde (DE); Romy Jaeschke, Chemnitz (DE)

(73) Assignee: BAYER MATERIALSCIENCE AG, Leverkusen (DE)

(21) Appl. No.: 13/065,412

(22) Filed: Mar. 22, 2011

(30) Foreign Application Priority Data
Mar. 26, 2010 (EP) 10003274.7

(51) Int. Cl. B32B 27/08

(52) U.S. Cl. 428/419

(57) ABSTRACT

The present invention provides a polymer laminar composite including a first layer and a second layer at least partially in contact with the first layer. The first layer includes a polyurethane polymer which is the reaction product of a polyisocyanate A) and/or a polyisocyanate prepolymer B) with an at least difunctional, isocyanate-group-reactive compound C) and a monomeric, monofunctional aromatic alcohol. The second layer includes polymeric thiophene of the formula (I), substituted at the 3 and/or 4 position:

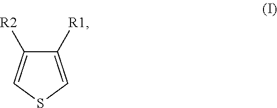

and polystyrene sulfonate. 2-Hydroxymethyl-3,4-ethylene dioxythiophene is preferably used for the first layer and poly(3,4-ethylene dioxythiophene) for the second layer. The invention further relates to a process for producing such a laminar composite, as well as an electromechanical converter containing this laminar composite.

### FIELD OF THE INVENTION

The present invention relates to a polymer laminar composite including a first layer and a second layer at least partially in contact with the first layer, wherein the first layer includes a polyurethane polymer and the second layer includes thiophene polymers and polystyrene sulfonate. The invention further relates to a process for producing such a laminar composite and an electromechanical converter, which includes such a laminar composite.

### BACKGROUND OF THE INVENTION

To produce dielectric elastomeric actuators, a film of a dielectric elastomer, which is an insulator, is conventionally provided on both sides with electrodes. The dielectric elastomer can be polyurethane, for example. It is favorable here if the electrodes are applied to the elastomer in the form of a coating. This requires certain properties of the electrode material, in particular an adequate elasticity, without losing electrical conductivity, and the possibility of being able to apply the electrode as a layer.

Extensible electrically conductive materials based on poly(ethylene dioxythiophene) (PEDOT) and polyurethane elastomers are described for example in the publication by N. B. Larsen et al., Adv. Funct. Mater. 2007, 17, 3069-3073. Here, however, a polymer blend of PEDOT:p-tosylate and an aliphatic polyurethane elastomer is used. It is produced by polymerizing EDOT in a solution of the polyurethane in tetrahydrofuran. The composition is then applied to a substrate and the solvent is evaporated. From a cost perspective in particular, the disadvantage of this process is that a polyurethane polymer has to be used as the matrix. Furthermore, the necessary solvents, in this case tetrahydrofuran, might not be compatible with all substrate surfaces.

A process proposed in WO 2008/064878 A1 relates to a process for producing an electrochromic material based on hydroxymethyl-substituted EDOT or hydroxypropylene dioxythiophene. The adhesion to substrates is emphasized here. However, extensive downstream chemistry is necessary in order to coat suitable surfaces with the desired material.

Polymer blends of polystyrene sulfonate (PSS) and PEDOT are frequently used as electrically conductive polymers. One of the greatest obstacles to their practical use, however, is their poor adhesion to many substrates. With regard to contact with dielectric elastomers, this relates in particular to the delamination of a PSS:PEDOT layer from the elastomer layer when the elastomer is deflected.

As a consequence of this, the possibility of improving the adhesion of PSS:PEDOT layers to polyurethane substrates would be desirable.

### SUMMARY OF THE INVENTION

The present invention relates to a polymer laminar composite including a first layer and a second layer at least partially in contact with the first layer. The first layer includes a polyurethane polymer which is the reaction product of a polyisocyanate A) and/or a polyisocyanate prepolymer B) with an at least difunctional, isocyanate-group-reactive compound C) and a monomeric, monofunctional aromatic alcohol. The second layer includes polymeric thiophene of the formula (I), substituted at the 3 and/or 4 position:

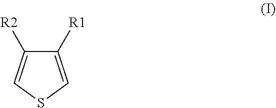

and polystyrene sulfonate. The invention further relates to a process for producing such a laminar composite, as well as an electromechanical converter containing this laminar composite.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the FIGURES, wherein:

FIG. 1 shows a plot of the specific electrical resistance ρ, calculated from the resistance of the electrode between the clamps of the tensile testing machine.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a polymer laminar composite which includes a first layer and a second layer at least partially in contact with the first layer, wherein the first layer includes a polyurethane polymer which is the reaction product of a polyisocyanate A) and/or a polyisocyanate prepolymer B) with an at least difunctional, isocyanate-group-reactive compound C) and a monomeric, monofunctional aromatic alcohol; and

the second layer includes polymeric thiophene of the formula (I), substituted at the 3 and/or 4 position:

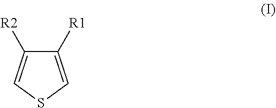

wherein: R1 and R2 are, independently of each other, hydrogen, alkyl, aryl, alkoxy, aryloxy, or R1 and R2 together form an unsubstituted or substituted alkylene dioxy group
   and polystyrene sulfonate.

It is assumed that the monomeric, monofunctional aromatic alcohol reacts with isocyanate groups during polyurethane production and is thus covalently bonded into the polymer. It was found that this leads to an improved adhesion of the second layer. Without being limited to one theory, the present inventors believe attractive interactions between the π-electron systems of the components are assumed to be responsible for this. This process is also known by the term “π-π stacking”. Extensible electrodes can be designed which can be operated within larger extension ranges.

Suitable monomeric, monofunctional aromatic alcohols include carbocyclic or heterocyclic aromatics such as benzyl alcohol and/or monohydroxy- or monohydroxyalkyl-substituted thiophenes, furans and/or pyrroles. The OH group is preferably bonded to the aromatic nucleus via one, two, three, four or even more methylene groups at the 2 or 3 position. This makes it easier to align the aromatic ring for the desired π-π stacking.

A suitable form of the polystyrene sulfonate is in particular sodium polystyrene sulfonate.

In the context of the present invention, the term “alkyl” is meant to encompass substituents from the group including n-alkyl such as methyl, ethyl or propyl, branched alkyl and/or cycloalkyl. In the context of the present invention, the term “aryl” is meant to encompass substituents from the group including mononuclear carboaryl or heteroaryl substituents such as phenyl and/or polynuclear carboaryl or heteroaryl substituents. The same applies to the terms “alkoxy” and “aryloxy”.

Examples of unsubstituted alkylene dioxy groups —O—[CH₂]ₙ—O— include methylene dioxy (—O—[CH₂]—O—), ethylene dioxy (—O—[CH₂]₂—O—), propylene dioxy (—O—[CH₂]₃—O—) and butylene dioxy (—O—[CH₂]₄—O—). In substituted alkylene dioxy groups, there are further substituents at the [CH₂]ₙ groups. Each carbon atom of an ethylene dioxy group, for example, can carry a methyl substituent (—O—[CH(CH₃)₂]₂—O—). Further substituents for alkylene dioxy groups can be inter alia hydroxyl and hydroxymethyl groups.

1,4-Butylene diisocyanate, 1,6 hexamethylene diisocyanate (HDI), isophorone diisocyanate (IPDI), 2,2,4- and/or 2,4,4-trimethylhexamethylene diisocyanate, the isomeric bis-(4,4′-isocyanatocyclohexyl)methanes or mixtures thereof with any isomer content, 1,4-cyclohexylene diisocyanate, 4-isocyanatomethyl-1,8-octane diisocyanate (nonane triisocyanate), 1,4-phenylene diisocyanate, 2,4- and/or 2,6-toluoylene diisocyanate, 1,5-naphthylene diisocyanate, 2,2′- and/or 2,4′- and/or 4,4′-diphenylmethane diisocyanate, 1,3- and/or 1,4-bis-(2-isocyanatoprop-2-yl)benzene (TMXDI), 1,3-bis(isocyanatomethyl)benzene (XDI), alkyl-2,6-diisocyanatohexanoates (lysine diisocyanates) with alkyl groups having 1 to 8 carbon atoms and mixtures thereof, for example, are suitable as the polyisocyanate and component A). Furthermore, compounds containing uretdione, isocyanurate, biuret, iminooxadiazinedione or oxadiazinetrione structures and based on the cited diisocyanates are suitable structural units of component A).

In one embodiment of the present invention, component A) may be a polyisocyanate or a polyisocyanate mixture having an average NCO functionality of 2 to 4 with exclusively aliphatically or cycloaliphatically bonded isocyanate groups. These are preferably polyisocyanates or polyisocyanate mixtures of the aforementioned type having a uretdione, isocyanurate, biuret, iminooxadiazinedione or oxadiazinetrione structure as well as mixtures thereof and an average NCO functionality of the mixture of 2 to 4, preferably 2 to 2.6 and particularly preferably 2 to 2.4.

Polyisocyanates based on hexamethylene diisocyanate, isophorone diisocyanate or the isomeric bis-(4,4′-isocyanatocyclohexyl)methanes and mixtures of the aforementioned diisocyanates are particularly preferred as component A).

The polyisocyanate prepolymers, which can be used as component B), may be obtained by reacting one or more diisocyanates with one or more hydroxy-functional, in particular polymeric, polyols, optionally with the addition of catalysts as well as auxiliary substances and additives. Furthermore, components for chain extension, such as for example those having primary and/or secondary amino groups (NH₂ and/or NH-functional components), may additionally be used for the formation of the polyisocyanate prepolymer.

The polyisocyanate prepolymer as component B) may preferably be obtained from the reaction of polymeric polyols and aliphatic diisocyanates. Polyisocyanate prepolymers based on polypropylene glycol as the polyol and hexamethylene diisocyanate as the aliphatic diisocyanate are preferred in the present invention as component B).

Hydroxy-functional, polymeric polyols for the reaction to form the polyisocyanate prepolymer B) may also be, for example, polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and/or polyester polycarbonate polyols. These may be used individually or in any mixtures with one another to produce the polyisocyanate prepolymer.

Suitable polyester polyols for producing the polyisocyanate prepolymers B) may be polycondensates of diols and optionally triols and tetraols and dicarboxylic and optionally tricarboxylic and tetracarboxylic acids or hydroxycarboxylic acids or lactones. In place of the free polycarboxylic acids, the corresponding polycarboxylic anhydrides or corresponding polycarboxylic acid esters of low alcohols may also be used to produce the polyesters.

Examples of suitable diols include ethylene glycol, butylene glycol, diethylene glycol, triethylene glycol, polyalkylene glycols such as polyethylene glycol, also 1,2-propanediol, 1,3-propanediol, butanediol(1,3), butanediol(1,4), hexanediol(1,6) and isomers, neopentyl glycol or hydroxypivalic acid neopentyl glycol ester or mixtures thereof, with hexanediol(1,6) and isomers, butanediol(1,4), neopentyl glycol and hydroxypivalic acid neopentyl glycol ester being preferred. In addition, polyols such as trimethylolpropane, glycerol, erythritol, pentaerythritol, trimethylolbenzene or tris-hydroxyethyl isocyanurate or mixtures thereof may also be used.

Phthalic acid, isophthalic acid, terephthalic acid, tetrahydrophthalic acid, hexahydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid and/or 2,2-dimethyl succinic acid may be used in the present invention as dicarboxylic acids. The corresponding anhydrides may also be used as the acid source.

Provided that the average functionality of the polyol to be esterified is ≧2, monocarboxylic acids, such as benzoic acid and hexanecarboxylic acid, may additionally also be used.

Preferred acids include aliphatic or aromatic acids of the aforementioned type. Adipic acid, isophthalic acid and phthalic acid are particularly preferred.

Hydroxycarboxylic acids which may additionally be used as reactants in the production of a polyester polyol having terminal hydroxyl groups include, for example, hydroxycaproic acid, hydroxybutyric acid, hydroxydecanoic acid or hydroxystearic acid or mixtures thereof. Suitable lactones are caprolactone, butyrolactone or homologues or mixtures thereof. Caprolactone is preferred here.

Polycarbonates containing hydroxyl groups, for example polycarbonate polyols, preferably polycarbonate diols, may likewise be used to produce the polyisocyanate prepolymers B). They can have a number-average molecular weight Mₙ of 400 g/mol to 8000 g/mol, for example, preferably 600 g/mol to 3000 g/mol. They may be obtained by reacting carbonic acid derivatives, such as diphenyl carbonate, dimethyl carbonate or phosgene, with polyols, preferably diols.

Examples of diols which are suitable for this purpose include ethylene glycol, 1,2- and 1,3-propanediol, 1,3- and 1,4-butanediol, 1,6-hexanediol, 1,8-octanediol, neopentyl glycol, 1,4-bishydroxymethyl cyclohexane, 2-methyl-1,3-propanediol, 2,2,4-trimethylpentanediol-1,3, dipropylene glycol, polypropylene glycols, dibutylene glycol, polybutylene glycols, bisphenol A or lactone-modified diols of the aforementioned type or mixtures thereof.

The diol component preferably contains from 40 percent by weight to 100 percent by weight of hexanediol, preferably 1,6-hexanediol and/or hexanediol derivatives. Such hexanediol derivatives are based on hexanediol and can have ester or ether groups in addition to terminal OH groups. Such derivatives may be obtained, for example, by reacting hexanediol with excess caprolactone or by etherifying hexanediol with itself to form dihexylene or trihexylene glycol. In the context of the present invention, the amounts of these and other components are chosen in a known manner such that the sum does not exceed 100 percent by weight and in particular adds to 100 percent by weight.

Polycarbonates having hydroxyl groups, in particular polycarbonate polyols, preferably have a linear structure.

Polyether polyols likewise may be used to produce the polyisocyanate prepolymers B). Polytetramethylene glycol polyethers such as are obtained by polymerization of tetrahydrofuran by cationic ring opening are suitable, for example. Likewise, suitable polyether polyols may be the addition products of styrene oxide, ethylene oxide, propylene oxide, butylene oxide and/or epichlorohydrin to difunctional or polyfunctional starter molecules. Water, butyl diglycol, glycerol, diethylene glycol, trimethylolpropane, propylene glycol, sorbitol, ethylene diamine, triethanolamine or 1,4-butanediol or mixtures thereof, for example, may be suitable starter molecules.

Preferred components for producing the polyisocyanate prepolymers B) include polypropylene glycol, polytetramethylene glycol polyether and polycarbonate polyols or mixtures thereof, with polypropylene glycol being particularly preferred.

Polymeric polyols preferably having a number-average molecular weight Mₙ of 400 g/mol to 8000 g/mol, more preferably 400 g/mol to 6000 g/mol and most preferably 600 g/mol to 3000 g/mol may be used in the present invention. These preferably have an OH functionality of 1.5 to 6, more preferably 1.8 to 3, and most particularly preferably 1.9 to 2.1.

In addition to the above-mentioned polymeric polyols, short-chain polyols may also be useful in the production of the polyisocyanate prepolymers B). For example, ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A, (2,2-bis(4-hydroxycyclohexyl)propane), trimethylolpropane, trimethylolethane, glycerol or pentaerythritol or a mixture thereof may be used.

Ester diols of the preferred molecular weight range such as α-hydroxybutyl-ε-hydroxyhexanoic acid ester, ω-hydroxyhexyl-γ-hydroxybutyric acid ester, adipic acid-(β-hydroxyethyl)ester or terephthalic acid-bis(β-hydroxyethyl)ester may also be suitable.

Monofunctional isocyanate-reactive hydroxyl-group-containing compounds may also be used to produce the polyisocyanate prepolymers B). Examples of such monofunctional compounds include ethanol, n-butanol, ethylene glycol monobutyl ether, diethylene glycol monomethyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol or 1-hexadecanol or mixtures thereof.

To produce the polyisocyanate prepolymers B) diisocyanates may preferably be reacted with the polyols in a ratio of isocyanate groups to hydroxyl groups (NCO/OH ratio) of 2:1 to 20:1, for example 8:1. Urethane and/or allophanate structures can be formed in this process. A proportion of unreacted polyisocyanates may be separated off subsequently. A film distillation process may be used to this end, for example, wherein low-residual-monomer products having residual monomer contents of preferably ≦1 percent by weight, more preferably ≦0.5 percent by weight, most preferably ≦0.1 percent by weight, are obtained. The reaction temperature preferably may be from 20° C. to 120° C., more preferably from 60° C. to 100° C. Stabilizers such as benzoyl chloride, isophthaloyl chloride, dibutyl phosphate, 3-chloropropionic acid or methyl tosylate may optionally be added during production.

Furthermore, NH₂— and/or NH-functional components may additionally be included for chain extension during production of the polyisocyanate prepolymers B).

Suitable components for chain extension include organic diamines or polyamines. For example, ethylene diamine, 1,2-diaminopropane, 1,3-diaminopropane, 1,4-diaminobutane, 1,6-diaminohexane, isophorone diamine, a mixture of isomers of 2,2,4- and 2,4,4-trimethyl hexamethylene diamine, 2-methyl pentamethylene diamine, diethylene triamine, diaminodicyclohexyl methane or dimethyl ethylene diamine or mixtures thereof may be used.

Moreover, compounds which in addition to a primary amino group also have secondary amino groups or which in addition to an amino group (primary or secondary) also have OH groups, may also be used to produce the polyisocyanate prepolymers B). Examples thereof include primary/secondary amines such as diethanolamine, 3-amino-1-methylaminopropane, 3-amino-1-ethylaminopropane, 3-amino-1-cyclohexylaminopropane, 3-amino-1-methylaminobutane, alkanol amines such as N-aminoethyl ethanolamine, ethanolamine, 3-aminopropanol, neopentanolamine. Amines having an isocyanate-reactive group, such as methylamine, ethylamine, propylamine, butylamine, octylamine, laurylamine, stearylamine, isononyl oxypropylamine, dimethylamine, diethylamine, dipropylamine, dibutylamine, N-methylaminopropylamine, diethyl(methyl)aminopropylamine, morpholine, piperidine, or suitable substituted derivatives thereof, amidoamines of diprimary amines and monocarboxylic acids, monoketimes of diprimary amines, primary/tertiary amines, such as N,N-dimethylaminopropylamine, may be used for chain termination.

The polyisocyanate prepolymers or mixtures thereof used as component B) preferably have an average NCO functionality of 1.8 to 5, more preferably 2 to 3.5, and most preferably 2 to 2.5.

Component C) is a compound having at least two isocyanate-reactive functional groups. For example, component C) may be a polyamine or a polyol having at least two isocyanate-reactive hydroxyl groups.

Hydroxy-functional, in particular polymeric, polyols, for example polyether polyols, may be used as component C). Polytetramethylene glycol polyethers, such as are obtained by polymerization of tetrahydrofuran by cationic ring opening, may be suitable, for example. Likewise, suitable polyether polyols may be the addition products of styrene oxide, ethylene oxide, propylene oxide, butylene oxide and/or epichlorohydrin to difunctional or polyfunctional starter molecules. Water, butyl diglycol, glycerol, diethylene glycol, trimethylolpropane, propylene glycol, sorbitol, ethylene diamine, triethanolamine or 1,4-butanediol or mixtures thereof, for example, may be suitable starter molecules.

It is preferable for component C) to be a polymer having 2 to 4 hydroxyl groups per molecule, most preferably a polypropylene glycol having 2 to 3 hydroxyl groups per molecule.

According to the invention the polymeric polyols from C) preferably have a particularly narrow molecular weight distribution, in other words a polydispersity (PD=Mw/Mn) of 1.0 to 1.5 and/or an OH functionality of greater than 1.9. The preferred polyether polyols preferably have a polydispersity of 1.0 to 1.5 and an OH functionality of greater than 1.9, more preferably greater than or equal to 1.95.

Such polyether polyols may be produced in a manner known to those skilled in the art by alkoxylation of suitable starter molecules, in particular using double metal cyanide catalysts (DMC catalysis). This method is described for example in the U.S. Pat. No. 5,158,922 and in the laid-open patent application EP 0 654 302 A1.

The reaction mixture for the polyurethane may be obtained by mixing components A), B) and C). The ratio of isocyanate-reactive hydroxyl groups to free isocyanate groups is preferably from 1:1.5 to 1.5:1, more preferably from 1:1.02 to 1:0.95.

At least one of components A), B) or C) preferably has a functionality of ≧2.0, more preferably ≧2.5, and most preferably ≧3.0, to introduce a branching or crosslinking into the polymer element. The term “functionality” refers in components A) and B) to the average number of NCO groups per molecule and in component C) to the average number of OH groups per molecule. This branching or crosslinking brings about better mechanical properties and better elastomeric properties, in particular, better extension properties.

The polyurethane may advantageously have good mechanical strength and high elasticity. In particular, the polyurethane may preferably have a maximum stress of ≧0.2 MPa, more preferably 0.4 MPa to 50 MPa, and a maximum extension of preferably ≧250%, more preferably ≧350%. In the working extension range of 50% to 200% the polyurethane may moreover have a stress of preferably 0.1 MPa to 1 MPa, more preferably 0.1 MPa to 0.8 MPa, most preferably 0.1 MPa to 0.3 MPa (determined in accordance with DIN 53504). Furthermore, the polyurethane may preferably have an elasticity modulus at an extension of 100% of 0.1 MPa to 10 MPa, more preferably 0.2 MPa to 5 MPa (determined in accordance with DIN EN 150 672 1-1).

In addition, the polyurethane may advantageously have good electrical properties; these can be determined in accordance with ASTM D 149 for the disruptive strength and in accordance with ASTM D 150 for the dielectric constant measurements.

In addition to components A), B) and C), the reaction mixture may additionally also contain auxiliary substances and additives as known to those skilled in the art. Examples of such auxiliary substances and additives include crosslinkers, thickeners, co-solvents, thixotropic agents, stabilizers, antioxidants, light stabilizers, emulsifiers, surfactants, adhesives, plasticizers, hydrophobing agents, pigments, fillers and flow control agents.

Fillers can regulate the dielectric constant of the polymer element, for example. The reaction mixture may preferably include fillers to increase the dielectric constant, such as fillers having a high dielectric constant. Examples thereof include ceramic fillers, in particular barium titanate, titanium dioxide and piezoelectric ceramics such as quartz or lead zirconium titanate, as well as organic fillers, in particular those having a high electrical polarizing capacity, for example phthalocyanines.

A high dielectric constant may also be achieved by the introduction of electrically conductive fillers below the percolation threshold. Examples include carbon black, graphite, single-walled or multi-walled carbon nanotubes, electrically conductive polymers such as polythiophenes, polyanilines or polypyrroles, or mixtures thereof. Carbon black types, which exhibit surface passivation and which thus increase the dielectric constant below the percolation threshold at low concentrations yet do not lead to an increase in the conductivity of the polymer, are of particular interest in this context.

It should be noted that the term “a” or “an” in connection with the present invention and in particular with components A), B) and C) is used not as a numeral but as an indefinite article, unless the context clearly indicates a different interpretation.

In an embodiment of the polymer laminar composite according to the invention the monomeric, monofunctional aromatic alcohol is a 2-hydroxymethylthiophene of the formula (II), substituted at the 3 and/or 4 position:

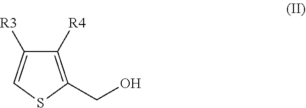

wherein: R3 and R4 are independently of each other hydrogen, alkyl, aryl, alkoxy, aryloxy, or R3 and R4 together form an unsubstituted or substituted alkylene dioxy group.

Examples of unsubstituted alkylene dioxy groups —O—[CH₂]ₙ—O— include methylene dioxy (—O—[CH₂]—O—), ethylene dioxy (—O—[CH₂]₂—O—), propylene dioxy (—O—[CH₂]₃—O—) and butylene dioxy (—O—[CH₂]₄—O—). In substituted alkylene dioxy groups there are further substituents at the [CH₂]ₙ groups. Each carbon atom of an ethylene dioxy group, for example, may carry a methyl substituent (—O—[CH(CH₃)₂]₂—O—). Further substituents for alkylene dioxy groups can be inter alia hydroxyl and hydroxymethyl groups.

In a further embodiment of the polymer laminar composite according to the invention, R3 and R4 together form an ethylene dioxy group. The monomeric, monofunctional aromatic alcohol is then the substituted thiophene (II), namely 2-hydroxymethyl-3,4-ethylene dioxythiophene, as shown in formula (IIa):

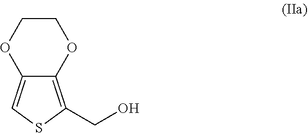

In another embodiment of the polymer laminar composite according to the invention, the second layer includes polystyrene sulfonate and poly(3,4-ethylene dioxythiophene). This mixture is available commercially under the name “PSS:PEDOT”.

In yet a further embodiment of the polymer laminar composite according to the invention, the molar ratio between the difunctional, isocyanate-group-reactive compound C) and the monomeric, monofunctional alcohol is in a range from preferably ≧50:100 to ≦100:50, more preferably ≧70:100 to ≦100:70. There is preferably a slight molar excess of the monomeric alcohol. For example, the ratio may be in a range from ≧100:80 to ≦100:90.

In still a further embodiment of the laminar composite according to the invention, the first layer is in contact on opposite sides with layers corresponding to the second layer in each case. In this way, an elastomer layer in contact with electrodes on both sides may be obtained.

The present invention also relates to a process for producing a polymer laminar composite according to the invention involving the following steps:

Provision of a polyurethane polymer which is obtained from the reaction of a polyisocyanate A) and/or a polyisocyanate prepolymer B) with an at least difunctional, isocyanate-group-reactive compound C) and a monomeric, monofunctional aromatic alcohol; and

at least partial bringing into contact of the polyurethane polymer with a mixture containing polymeric thiophene of the formula (III), substituted at the 3 and/or 4 position:

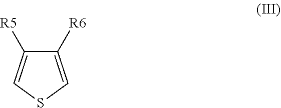

wherein: R5 and R6 are independently of each other hydrogen, alkyl, aryl, alkoxy, aryloxy, or R5 and R6 together form an unsubstituted or substituted alkylene dioxy group
   and polystyrene sulfonate.

In one embodiment of the process according to the invention, the monomeric, monofunctional aromatic alcohol is a 2-hydroxymethylthiophene of the formula (IV), substituted at the 3 and/or 4 position:

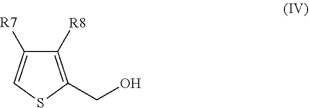

wherein: R7 and R8 are independently of each other hydrogen, alkyl, aryl, alkoxy, aryloxy, or R7 and R8 together form an unsubstituted or substituted alkylene dioxy group.

Further examples of monomeric, monofunctional aromatic alcohols which can be used in the context of the invention include 3-Hydroxymethylthiophene and derivatives thereof substituted at the 2 and 4 position, 2-hydroxymethylfuran and derivatives thereof substituted at the 3 and 4 position, 3-hydroxymethylfuran and derivatives thereof substituted at the 2 and 4 position, 2-hydroxymethylpyrrole and derivatives thereof substituted at the 3 and 4 position, 3-hydroxymethylpyrrole and derivatives thereof substituted at the 2 and 4 position, 4-methoxybenzyl alcohol; 2-methoxybenzyl alcohol; 3-methoxybenzyl alcohol; furfuryl alcohol; tertiary amine-functionalized ethylene dioxythiophene derivatives.

In the process according to the invention, R7 and R8 preferably together form an ethylene dioxy group and 2-hydroxymethyl-3,4-ethylene dioxythiophene is used as the substituted thiophene (IV). It is likewise preferable for the polymeric thiophene (III) to be poly(3,4-ethylene dioxythiophene). The mixture thereof with polystyrene sulfonate is available commercially under the name “PSS:PEDOT”.

In a further embodiment of the process according to the invention, the mixture containing polystyrene sulfonate and polymeric thiophene of the formula (III), substituted at the 3 and/or 4 position, is present in the form of an aqueous dispersion.

The present invention also provides an extensible electrode made from a polymeric laminar composite according to the invention. Such an extensible electrode may find use, for example, in an electromechanical converter. The extensible electrode may preferably be constructed in such a way that the first layer containing the polyurethane polymer is at least partially in contact on both sides with layers corresponding to the aforementioned second layers, which are not electrically connected with one another.

Details of the polymer laminar composite including the embodiments have already been described above. To avoid unnecessary repetitions, reference is made hereto with regard to the use thereof.

The present invention further relates to an electromechanical converter including a polymer laminar composite according to the invention. The polymer laminar composite in the electromechanical converter is preferably constructed in such a way that the first layer containing the polyurethane polymer is at least partially in contact on both sides with layers corresponding to the aforementioned second layers, which are not electrically connected with one another. The laminar composite according to the invention may then function as a dielectric elastomer in contact on both sides.

If a mechanical load is applied to such a converter, the converter deforms along its thickness and its surface, for example, and a strong electrical signal may be detected at the electrodes. Mechanical energy may be converted into electrical energy in this way. The converter according to the invention may thus be used both as a generator and as a sensor.

By making use of the opposite effect, namely the conversion of electrical energy into mechanical energy, the converter according to the invention may on the other hand equally serve as an actuator.

Possible uses of such an electromechanical converter include a large number of diverse applications in the electromechanical and electroacoustical area, in particular in the area of energy recovery from mechanical vibrations (known as energy harvesting), acoustics, ultrasound, medical diagnostics, acoustic microscopy, mechanical sensors, in particular pressure, force and/or strain sensors, robotics and/or communication technology. Typical examples include pressure sensors, electroacoustical converters, microphones, loudspeakers, vibration converters, light deflectors, membranes, modulators for glass fiber optics, pyroelectric detectors, capacitors and control systems and “intelligent” floors as well as systems for converting wave energy, in particular tidal energy, into electrical energy.

Dielectric elastomers within the meaning of the present invention are elastomers that can change their shape through the application of an electric field. In the case of elastomer films the thickness may be reduced, for example, whilst at the same time the length of the film in the planar direction increases.

The thickness of the dielectric elastomer layer is preferably ≧1 μm to ≦500 μm and more preferably ≧10 μm to ≦100 μm. It can be constructed from one piece or from a plurality of pieces. For example, a multi-piece layer may be obtained by the lamination of individual layers on top of one another.

In addition to the polyurethane polymer provided according to the invention, the dielectric elastomer may also contain further constituents. Such constituents include, for example, crosslinkers, thickeners, co-solvents, thixotropic agents, stabilizers, antioxidants, light stabilizers, emulsifiers, surfactants, adhesives, plasticizers, hydrophobing agents, pigments, fillers and flow control agents.

Fillers in the elastomer can regulate the dielectric constant of the polymer, for example. Examples thereof include ceramic fillers, in particular barium titanate, titanium dioxide and piezoelectric ceramics such as quartz or lead zirconium titanate, as well as organic fillers, in particular those having a high electrical polarizing capacity, for example phthalocyanines.

A high dielectric constant may also be achieved by the introduction of electrically conductive fillers below their percolation threshold. Examples include carbon black, graphite, single-walled or multi-walled carbon nanotubes, electrically conductive polymers such as polythiophenes, polyanilines or polypyrroles, or mixtures thereof. Carbon black types, which exhibit surface passivation and which thus increase the dielectric constant below the percolation threshold at low concentrations yet do not lead to an increase in the conductivity of the polymer, are of particular interest in this context.

Details of the polymer laminar composite including the embodiments have already been described above. To avoid unnecessary repetitions, reference is made hereto with regard to the use thereof in an electromechanical converter.

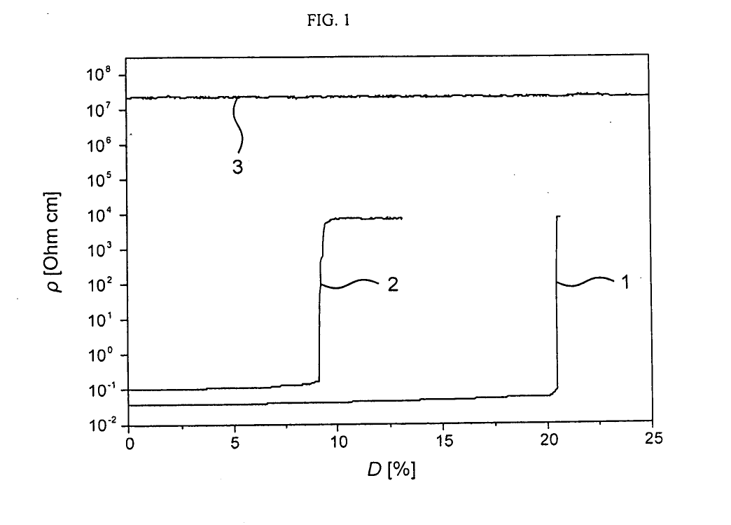

The present invention is illustrated in more detail by the examples below in conjunction with FIG. 1, without however being restricted thereto.

Solvents were obtained from Merck, Fluka, Lancaster and Aldrich, dried by means of the conventional drying agents and redistilled. 3,4-Ethylene dioxythiophene was obtained from Clevios GmbH and phosphorus oxychloride from ACROS Organics (99%).

The synthesis of 2-hydroxymethyl-3,4-ethylene dioxythiophene was carried out by reducing the corresponding aldehyde (2-formyl-3,4-ethylene dioxythiophene) with sodium boron hydride.

### Example 1

### Synthesis of 2-formyl-3,4-ethylene dioxythiophene

10.00 g (70.35 mmol) of 3,4-ethylene dioxythiophene and 0.68 g (77.76 mmol, 1.1 eq) of dry N,N-dimethylformamide were dissolved in 15 ml of dry dichloromethane in a 100-ml three-necked flask under protective gas. 11.92 g (77.76 mmol, 1.1 eq) of phosphoryl chloride were added dropwise at 0° C. and the mixture was stirred for a further 10 min. Then the reaction mixture was refluxed for two hours. Over the course of the reaction, the reaction mixture slowly turned red in color. On completion of the reaction, the reaction mixture was poured into 400 ml of ice-cooled water and stirred for one hour. The aqueous and organic phases were separated in a separating funnel. After some time, colorless to pink needles precipitated out of the aqueous phase. Recrystallization from dichloromethane yielded 10.93 g (63.48 mmol, 90%) of 2-formyl-3,4-ethylene dioxythiophene as a colorless solid.

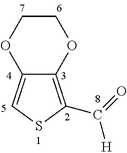

Melting point: 146.0° C.

IR (cm¹): \tilde{ν}=3108 (w) (ν=_{C—H}); 2842 (w) (ν_{C—H, aliph}); 1646 (s) (ν_{C═O, CHO}), 1487 (m) 1438 (s) (ν_{C═C thiophene}); 1383 (s), 1364 (s) (ν_{C—H}); 1259 (m), 1237 (m), 1174 (m), 1135 (m) (δ_{C—H thiophene}); 1063 (m), 1010 (m) (ν_{C—O—C}); 961 (m), 908 (m), 847 (w), 762 (s) (δ_{C—H thiophene}).

¹H-NMR (250.13 MHz, d¹-CHCl₃): δ [ppm]=9.88 (s, 1H, H-8), 6.78 (s, 1H, H-5), 4.37-4.24 (m, 4H, H-6, H-7).

¹³C-NMR (62.90 MHz, d¹-CHCl₃): δ [ppm]=180.2 (C-8), 148.6 (C-4), 141.9 (C-3), 118.6 (C-2), 110.8 (C-5), 65.4, 64.5 (C-6, C-7).

C₇H₆O₃S (170.19 gmol⁻¹). Elemental analysis: calculated: C, 49.40; H, 3.55; S, 18.84. found: C, 49.43; H, 3.59; S, 19.20 .

### Example 2

### Synthesis of 2-hydroxymethyl-3,4-ethylene dioxythiophene

11.60 g (68.18 mmol) of 2-formyl-3,4-ethylene dioxythiophene were dissolved in 200 ml of dry dichloromethane in a 1000-ml three-necked flask under protective gas and cooled to 0° C. 7.74 g (204.5 mmol, 3.0 eq) of NaBH₄ were dissolved in 200 ml of dry methanol and added slowly dropwise to the reaction mixture through a dropping funnel. The reaction solution was stirred overnight at room temperature. Then it was hydrolyzed with 800 ml of NaOH solution and stirred for a further 1 h. The organic phase was washed with distilled water and evaporated to dryness in a rotary evaporator. A pink oil was obtained, which crystallized out after some time. 10.93 g (63.48 mmol, 92%) of 2-hydroxymethyl-3,4-ethylene dioxythiophene were obtained as slightly pink solids.

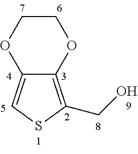

Melting point: 68.6° C.

IR (cm¹): \tilde{ν}=3368 (m), 3296 (m) (ν_{O—H}); 3126 (w) (ν_{C—H atom}); 2920 (w), 2867 (w) (ν_{C—H, aliph}); 1494 (s) 1441 (s) (ν_{C═C thiophene}); 1370 (m), 1339 (m) (δ_{C—H aliph}); 1243 (m), 1212 (m), 1160 (m), (δ_{C—H thiophene}); 1083 (m), 1040 (s) (ν_{C—O—C}); 972 (m), 930 (m), 892 (m) (δ_{C—H thiophene}).

¹H-NMR (250.13 MHz, d¹-CHCl₃): δ [ppm]=6.28 (s, 1H, H-5), 4.67 (d, 2H, H-8), 4.24-4.18 (m, 4H, H-6, H-7); 1.74 (t, 1H, H-9).

¹³C-NMR (62.90 MHz, d¹-CHCl₃): δ [ppm]=141.5 (C-4), 138.9 (C-3), 116.2 (C-2), 98.5 (C-5), 64.8, 64.6 (C-6, C-7), 55.97 (C-8).

C₇H₈O₃S (172.19 gmol⁻¹). Elemental analysis: calculated: C, 48.82; H, 4.68; S, 18.62. found: C, 48.83; H, 4.63; S, 18.95.

### Example 3

2.134 g of 2-hydroxymethyl-3,4-ethylene dioxythiophene (Mw: 172.17 g/mol) were dissolved in 42.68 g of a polyether polyol produced by the DMC catalysis with a molecular weight of 4000, a functionality of 2 and an ethylene oxide content of 15%. This corresponded to a molar ratio of thiophene to polyol of 100:86. Then 0.256 g of the catalyst dibutyl tin dilaurate (DBTL) were added whilst stirring. The second polyurethane component, 14 g of an HDI trimer (DESMODUR N 3300, Bayer MaterialScience AG), was added and the mixture was stirred in a SpeedMixer. Following homogeneous mixing of the components, they were applied to a PET substrate with a knife. The wet film thickness was 500 p.m. The coated substrates were then stored for 20 minutes in an oven preheated to 100° C. and allowed to cool to room temperature. A commercially available PSS:PEDOT suspension (AGFA ORGACON 6010) was applied with a knife in a wet film thickness of 500 μM and dried in the oven at 80° C. for 10 minutes.

FIG. 1 shows a plot of the specific electrical resistance p, calculated from the resistance of the electrode between the clamps of the tensile testing machine (DIN 53504) and the geometry of the electrode with a length of 30 mm, a width of 10 mm and a thickness of 4.14 μm, against the extension D for a laminar composite obtained in accordance with Example 3 (curve 1), for a polyurethane film analogous to that of Example 3 but without the thiophene from the example and with a PSS:PEDOT coating (curve 2) and for a polyurethane film analogous to that of Example 3, except that no 2-hydroxymethyl-3,4-ethylene dioxythiophene was used in the production thereof and it was not coated with PSS:PEDOT (curve 3). The specific resistance, where applied, was calculated from the PSS:PEDOT layer.

It can be appreciated that the film treated in curve 3 has a very high specific electrical resistance, irrespective of the degree of extension of the film. This is also in line with expectations. A comparison of curves 1 and 2 shows that the laminar composite according to the invention (curve 1) retains its low specific resistance in this context up to a markedly greater extension than a laminar composite in which 2-hydroxymethyl-3,4-ethylene dioxythiophene was not used in the production of the polyurethane (curve 2). This is consistent with an improved adhesion of the PSS:PEDOT layer in the laminar composite according to the invention.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A polymer laminar composite comprising:
a first layer including a polyurethane polymer comprising the reaction product of a polyisocyanate A) and/or a polyisocyanate prepolymer B) with an at least difunctional, isocyanate-group-reactive compound C) and a monomeric, monofunctional aromatic alcohol; and
a second layer at least partially in contact with the first layer, wherein the second layer includes polymeric thiophene of monomers of the formula (I), substituted at the 3 and/or 4 position: 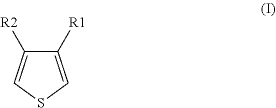
wherein: R1 and R2 are independently of each other hydrogen, alkyl, aryl, alkoxy, aryloxy, or R1 and R2 together form an unsubstituted or substituted alkylene dioxy group,
and polystyrene sulfonate.

2. The polymer laminar composite according to claim 1, wherein the monomeric, monofunctional aromatic alcohol comprises a 2-hydroxymethylthiophene of the formula (II), substituted at the 3 and/or 4 position: 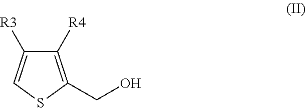
wherein: R3 and R4 are independently of each other hydrogen, alkyl, aryl, alkoxy, aryloxy, or R3 and R4 together form an unsubstituted or substituted alkylene dioxy group.

3. The polymer laminar composite according to claim 2, wherein R3 and R4 together form an ethylene dioxy group.

4. The polymer laminar composite according to claim 1, wherein the second layer includes polystyrene sulfonate and poly(3,4-ethylene dioxythiophene).

5. The polymer laminar composite according to claim 1, wherein the molar ratio between the difunctional, isocyanate-group-reactive compound C) and the monomeric, monofunctional alcohol is in a range from about ≧50:100 to about ≦100:50.

6. The polymer laminar composite according to claim 1, wherein the first layer is in contact on each opposite side with one or more layers corresponding to the second layer.

7. A process for producing a polymer laminar composite according to claim 1, comprising the following steps:
providing a polyurethane polymer comprising the reaction product of a polyisocyanate A) and/or a polyisocyanate prepolymer B) with an at least difunctional, isocyanate-group-reactive compound C) and a monomeric, monofunctional aromatic alcohol; and
contacting at least a portion of the polyurethane polymer with a mixture containing polymeric thiophene of monomers of the formula (III), substituted at the 3 and/or 4 position: 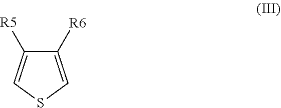
wherein: R5 and R6 are independently of each other hydrogen, alkyl, aryl, alkoxy, aryloxy, or R5 and R6 together form an unsubstituted or substituted alkylene dioxy group, and polystyrene sulfonate.

8. The process according to claim 7, wherein the monomeric, monofunctional aromatic alcohol comprises a 2-hydroxymethylthiophene of the formula (IV), substituted at the 3 and/or 4 position: 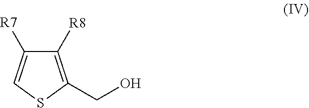
wherein: R7 and R8 are independently of each other hydrogen, alkyl, aryl, alkoxy, aryloxy, or R7 and R8 together form an unsubstituted or substituted alkylene dioxy group.

9. The process according to claim 8, wherein the mixture containing polystyrene sulfonate and polymeric thiophene of the formula (III), substituted at the 3 and/or 4 position, is in the form of an aqueous dispersion.

10. The process according to claim 8, wherein the molar ratio between the difunctional, isocyanate-group-reactive compound C) and the monomeric, monofunctional alcohol is in a range from about ≧50:100 to about ≦100:50.

11. An extensible electrode comprising the polymer laminar composite according to claim 1.

12. An electromechanical converter including a polymer laminar composite according to claim 1.
